(19) United States
(12) Patent Application Publication
(10) Pub. No.: US 2010/0191913 A1
(43) Pub. Date: Jul. 29, 2010

(54) RECONFIGURATION OF EMBEDDED MEMORY HAVING A MULTI-LEVEL CACHE

(75) Inventors: James D. Chlipala, Emmaus, PA (US); Richard P. Martin, Macungie, PA (US); Richard Muscavage, Gilbertsville, PA (US); Eric Wilcox, Allentown, PA (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/359,444

(22) Filed: Jan. 26, 2009

(51) Int. Cl. G06F 12/08

(52) U.S. Cl. 711/122; 711/E12.017

(57) ABSTRACT

A method of operating an embedded memory having (i) a local memory, (ii) a system memory, and (iii) a multi-level cache memory coupled between a processor and the system memory. According to one embodiment of the method, a two-level cache memory is configured to function as a single-level cache memory by excluding the level-two (L2) cache from the cache-transfer path between the processor and the system memory. The excluded L2-cache is then mapped as an independently addressable memory unit within the embedded memory that functions as an extension of the local memory, a separate additional local memory, or an extension of the system memory.

### BACKGROUND OF THE INVENTION

1. Field of the Invention

The present invention relates to memory circuits and, more specifically, to reconfiguration of embedded memory having a multi-level cache.

2. Description of the Related Art

This section introduces aspects that may help facilitate a better understanding of the inventions. Accordingly, the statements of this section are to be read in this light and are not to be understood as admissions about what is in the prior art or what is not in the prior art.

Embedded memory is any non-stand-alone memory. Embedded memory is often integrated on a single chip with other circuits to create a system-on-a-chip (SoC). Having an SoC is usually beneficial for one or more of the following reasons: a reduced number of chips in the end system, reduced pin count, lower board-space requirements, utilization of application-specific memory architecture, relatively low memory latency, reduced power consumption, and greater cost effectiveness at the system level.

Very-large-scale integration (VLSI) enables an SoC to have a hierarchical embedded memory. Memory hierarchy is a mechanism that helps a processor to optimize its memory access process. A representative hierarchical memory might have two or more of the following memory components: CPU registers, cache memory, and main memory. These memory components might further be differentiated into various memory levels that differ, e.g., in size, latency time, memory-cell structure, etc. It is not unusual that various embedded memory components and/or memory levels form a rather complicated memory structure.

### SUMMARY OF THE INVENTION

Problems in the prior art are addressed by a method of operating an embedded memory having (i) a local memory, (ii) a system memory, and (iii) a multi-level cache memory coupled between a processor and the system memory. According to one embodiment of the method, a two-level cache memory is configured to function as a single-level cache memory by excluding the level-two (L2) cache from the cache-transfer path between the processor and the system memory. The excluded L2-cache is then mapped as an independently addressable memory unit within the embedded memory that functions as an extension of the local memory, a separate additional local memory, or an extension of the system memory. The method can be applied to an embedded memory employed in a system-on-a-chip (SoC) having one or more processor cores to optimize its performance in terms of effective latency and/or effective storage capacity.

According to one embodiment, the present invention is a method of operating an embedded memory having the steps of: (A) excluding a first memory circuit of a first multi-level cache memory from a cache-transfer path that couples a first processor and a system memory and (B) mapping the first memory circuit as an independently addressable memory unit within the embedded memory. The embedded memory comprises the system memory and the first multi-level cache memory. The first multi-level cache memory is coupled between the first processor and the system memory and has (i) a first L1-cache directly coupled to the first processor and (ii) the first memory circuit coupled between the first L1-cache and the system memory.

According to another embodiment, the present invention is a method of operating an embedded memory having the step of engaging a first memory circuit of a first multi-level cache memory into a cache-transfer path that couples a first processor and a system memory. The embedded memory comprises the system memory and the first multi-level cache memory. The first multi-level cache memory is coupled between the first processor and the system memory and has (i) a first L1-cache directly coupled to the first processor and (ii) the first memory circuit coupled between the first L1-cache and the system memory. The first memory circuit is configurable to function as an independently addressable memory unit within the embedded memory if assigned a corresponding address range in a memory map of the embedded memory. The method further has the step of reserving in the memory map an address range for possible assignment to the first memory circuit.

According to yet another embodiment, the present invention is an embedded memory comprising: (A) a system memory; (B) a multi-level cache memory coupled between a first processor and the system memory, wherein the multi-level cache memory comprises (i) a first L1-cache directly coupled to the processor and (ii) a first memory circuit coupled between the first L1-cache and the system memory; and (C) a routing circuit that, in a first routing state, engages the first memory circuit into a cache-transfer path that couples the first processor and the system memory and, in a second routing state, excludes the first memory circuit from the cache-transfer path. The first memory circuit is configurable to function as (i) a level-two cache if engaged in the cache-transfer path and (ii) an independently addressable memory unit within the embedded memory if excluded from the cache-transfer path.

### BRIEF DESCRIPTION OF THE DRAWINGS

Other aspects, features, and benefits of the present invention will become more fully apparent from the following detailed description, the appended claims, and the accompanying drawings in which:

FIG. 1 shows a block diagram of a system-on-a-chip (SoC) in which various embodiments of the invention can be practiced;

FIG. 2 shows a configuration of the SoC shown in FIG. 1 according to one embodiment of the invention;

FIG. 3 shows a configuration of the SoC shown in FIG. 1 according to another embodiment of the invention;

FIG. 4 shows a block diagram of another SoC in which additional embodiments of the invention can be practiced; and

FIG. 5 shows a configuration of the SoC shown in FIG. 4 according to one embodiment of the invention.

### DETAILED DESCRIPTION

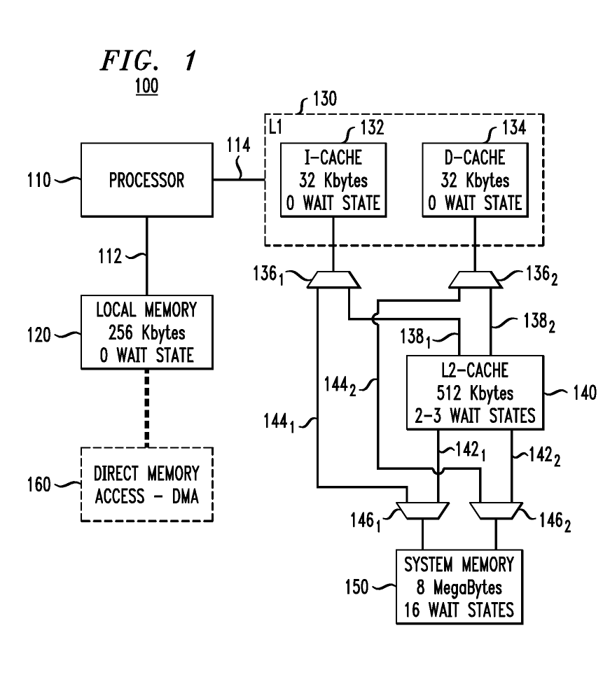

FIG. 1 shows a block diagram of a system-on-a-chip (SoC) 100 in which various embodiments of the invention can be practiced. SoC 100 has a processor (e.g., CPU) 110 that is coupled to a local memory 120 and a level-one (L1) cache 130 via buses 112 and 114, respectively. Both local memory 120 and L1-cache 130 are random-access memories (RAMs) characterized by an access time of zero clock cycles. An access time of zero clock cycles means that, in case of a memory hit, a datum (e.g., an instruction or a piece of application data) requested by processor 110 can be obtained from the corresponding memory component by the next clock cycle, i.e., the processor does not have to wait any additional clock cycles to obtain the datum. Due to this property, local memory 120 and L1-cache 130 are also referred to as “zero-wait-state” memories.

A cache-memory hit occurs if the requested datum is found in the corresponding cache-memory component. A cache-memory miss occurs if the requested datum is not found in the corresponding cache-memory component. A cache-memory miss normally (i) prompts the cache-memory component to retrieve the requested datum from a more-remote memory component, such as a level-two (L2) cache 140 or a system memory 150, and (ii) results in a processor stall at least for the time needed for the retrieval. Note that, in the relevant literature, a system memory that is generally analogous to system memory 150 might also be referred to as a main memory.

Local memory 120 is a high-speed on-chip memory that can be directly accessed by processor 110 via bus 112. Local memory 120 and L1-cache 130 are both located in similar proximity to processor 110 and are the next-closest memory components to the processor after the processor's internal registers (not explicitly shown in FIG. 1). Local memory 120 can be used by processor 110 for any purpose, such as storing instructions or application data, but is most beneficial for storing temporary results that do not necessarily need committing to system memory 150. As a result, local memory 120 often contains application data and/or instructions of which system memory 150 never has a copy. Alternatively or in addition, SoC 100 can use a direct-memory-access (DMA) controller 160 to move instructions and application data between local memory 120 and system memory 150, e.g., to mirror a portion of the contents from the system memory that is known to be critical to the speed of the running application. In one embodiment, local memory 120 might be used as a scratchpad memory (SPM). In the relevant literature, a local memory that is generally analogous to local memory 120 might also be referred to as a local store or a stream-register file.

L1-cache 130 has an instruction cache (I-cache) 132 and a data cache (D-cache) 134 configured to store instructions and application data, respectively, that processor 110 is working with at the time or is predicted to work with in the near future. To keep the instructions and application data current, SoC 100 continuously updates the contents of L1-cache 130 by moving instructions and/or application data between system memory 150 and the L1-cache. A transfer of instructions and application data between system memory 150 and L1-cache 130 can occur either directly or via L2-cache 140. For a direct transfer, 1×2 multiplexers (MUXes) 136 and 146 are configured to bypass L2-cache 140 by selecting lines 144₁ and 144₂. For a transfer via L2-cache 140, MUXes 136 and 146 are configured to select lines 138 and 142, respectively. MUXes 136 and 146 are collectively referred to as a routing circuit.

L2-cache 140 is generally larger than L1-cache 130. For example, in FIG. 1, L1-cache 130 and L2-cache 140 are illustratively shown as being 64 and 512 Kbytes, respectively, in size. At the same time, L2-cache 140 is slower than L1-cache 130 but faster than system memory 150. For example, in FIG. 1, L2-cache 140 and system memory 150 are shown as being characterized by a wait time of 2-3 and 16 clock cycles, respectively.

If MUXes 136 and 146 are configured to direct data transfers via L2-cache 140, then SoC 100 can operate for example as follows. If a copy of the datum requested by processor 110 is in L1-cache 130 (i.e., there is an L1-cache hit), then the L1-cache returns the datum to the processor. If a copy of the datum is not present in L1-cache 130 (i.e., there is an L1-cache miss), then the L1-cache passes the request on down to L2-cache 140. If a copy of the datum is in L2-cache 140 (i.e., there is an L2-cache hit), then the L2-cache returns the datum to L1-cache 130, which then provides the datum to processor 110. If L2-cache 140 does not have a copy of the datum (i.e., there is an L2-cache miss), then the L2-cache passes the request on down to system memory 150. System memory 150 then copies the datum to L2-cache 140, which passes it to L1-cache 130, which provides it to processor 110. Note that possible (not-too-remote) future requests for this datum received from processor 110 will be served from L1-cache 130 rather than from L2-cache 140 or system memory 150 because the L1-cache now has a copy of the datum.

An additional difference between L1-cache 130 and L2-cache 140 is in the amount of data that SoC 100 fetches into or from the cache. For example, when processor 110 fetches data from L1-cache 130, the processor generally fetches only the requested datum. However, in case of an L1-cache miss, L1-cache 130 does not simply read the requested datum from L2-cache 140 (assuming that it is present there). Instead, L1-cache 130 reads a whole block of data that contains the requested datum. One justification for this feature is that there generally exists some degree of data clustering due to which spatially adjacent pieces of data are often requested from the memory in close temporal succession. In case of an L2-cache miss, L2-cache 140 also reads from system memory 150 a whole block of data that contains the pertinent datum, with the data block read by the L2-cache from the system memory being even larger than the data block read by L1-cache 130 from the L2-cache in case of an L1-cache miss.

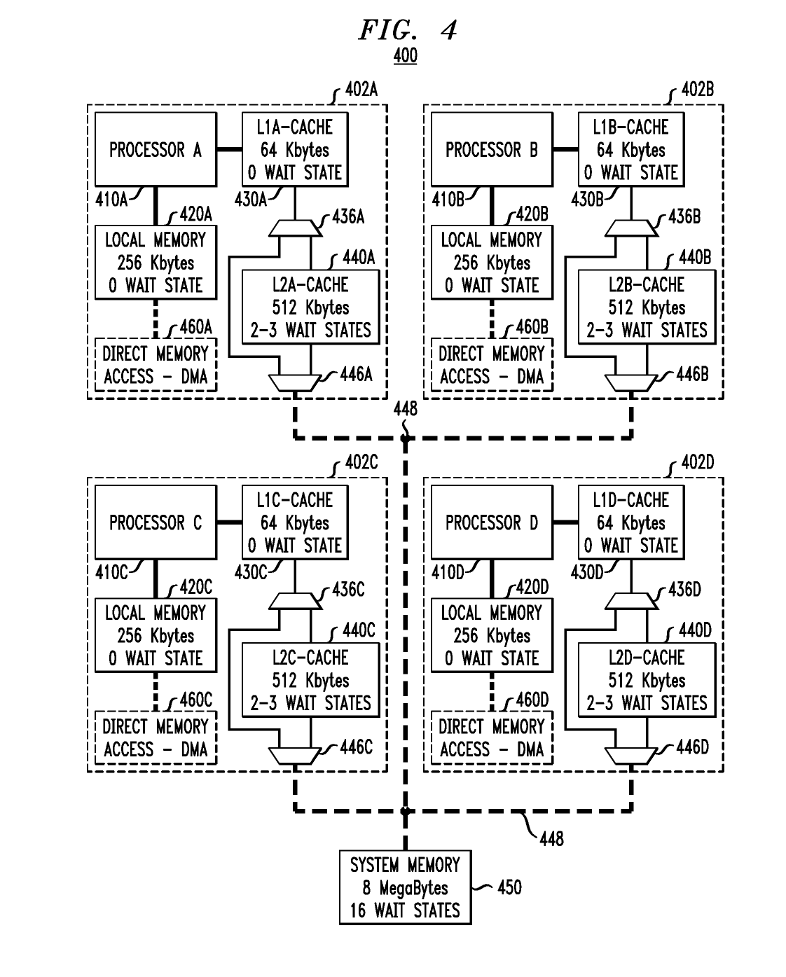

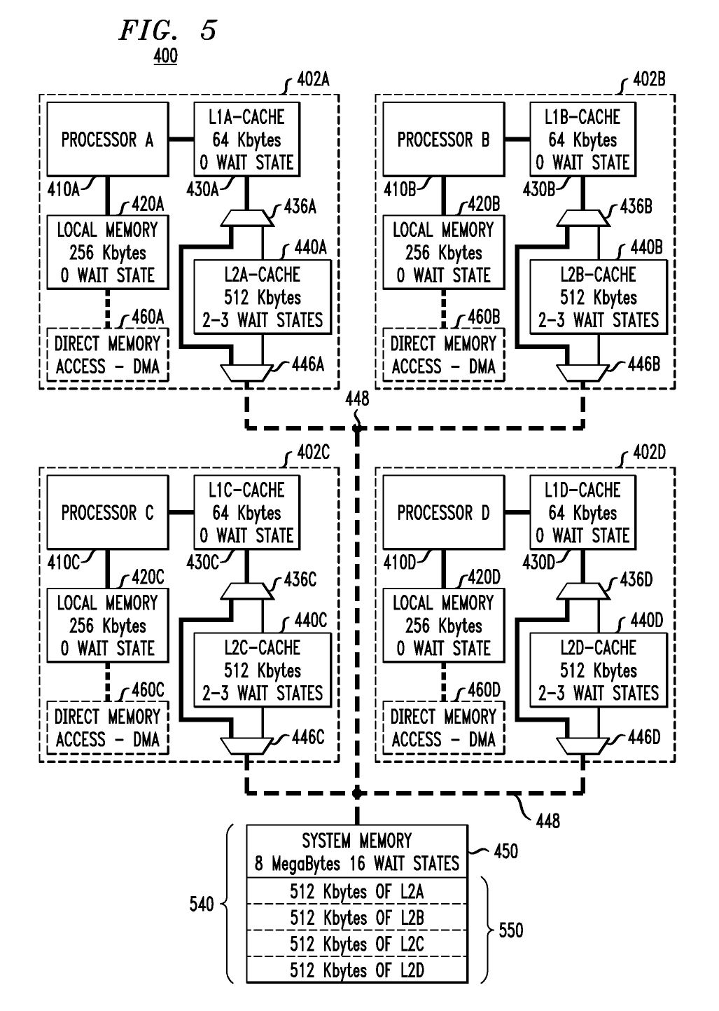

DMA controller 160 enables access to local memory 120, e.g., from system memory 150 and/or from certain other hardware subsystems (not explicitly shown in FIG. 1), such as a PCIe (peripheral component interconnect express) controller, a SRIO (serial rapid input output) controller, a disk-drive controller, a graphics card, a network card, a sound card, and a graphics processing unit (GPU), without significant intervention from processor 110. DMA controller 160 can also be used for intra-chip data transfers in an embodiment of SoC 100 having multiple instances of processor 110, each coupled to a corresponding local memory analogous to local memory 120 (see also FIGS. 4-5). Using its DMA functionality, SoC 100 can transfer data between local memory 120 and other devices with a much lower processor overhead than without the DMA functionality. The DMA functionality might be particularly beneficial for real-time computing applications, where a processor stall caused by a data transfer might render the application unreceptive to critical real-time inputs, and for various forms of stream processing, where the speed of data processing and transfer has to meet a certain minimum threshold imposed by the bit rate of the incoming/outgoing data stream.

In one embodiment, DMA controller 160 is connected to an on-chip bus (not explicitly shown in FIG. 1) and runs a DMA engine that administers data transfers in coordination with a flow-control mechanism of the on-chip bus. To initiate a data transfer to or from local memory 120, processor 110 issues a DMA command that specifies a local address and a remote address. For example, for a transfer from local memory 120 to system memory 150, the DMA command specifies (i) a memory address corresponding to the local memory as a source, (ii) a memory address corresponding to the system memory as a target, and (iii) a size of the data block to be transferred. Upon receiving the DMA command from processor 110, DMA controller 160 takes over the transfer operation, thereby freeing the processor for other operations for the duration of the transfer. Upon completing the transfer, DMA controller 160 informs processor 110 about the completion, e.g., by sending an interrupt to the processor.

Although FIG. 1 shows various memory components of SoC 100 as having specific sizes and latencies, various embodiments of the invention are not so limited. One of ordinary skill in the art will appreciate that local memory 120, I-cache 132, D-Cache 134, L2-cache 140, and system memory 150 might have sizes and/or latencies that are different from those shown in FIG. 1. Although L1-cache 130 is shown in FIG. 1 as having a so-called “Harvard architecture,” which is characterized by separate I-cache and D-cache data-routing paths, various embodiments of the invention can similarly be practiced with an L1-cache having a different suitable architecture, already known in the art or to be developed in the future.

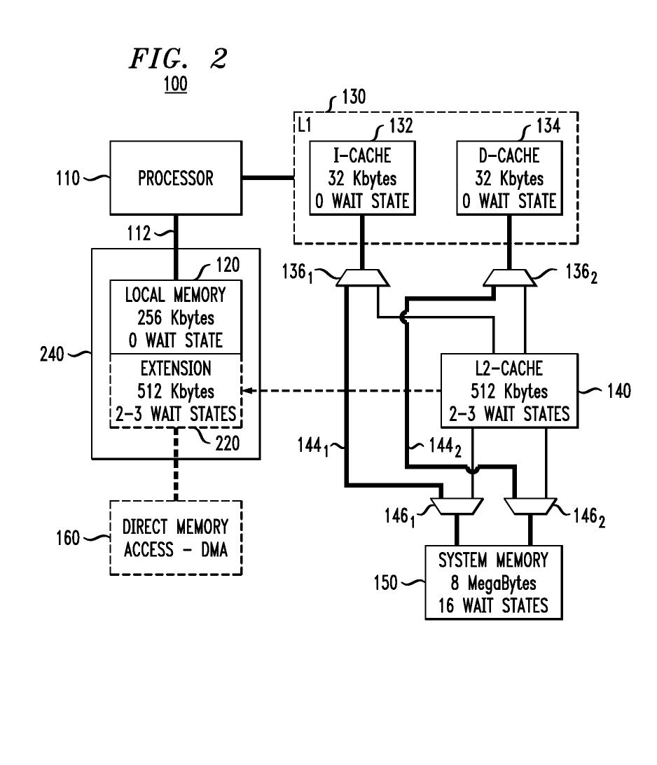

FIG. 2 shows a configuration of SoC 100 according to one embodiment of the invention. More specifically, in the configuration of FIG. 2, MUXes 136 and 146 are configured to select lines 144₁ and 144₂, which enables a direct transfer of instructions and application data between system memory 150 and L1-cache 130. At the same time, L2-cache 140 is excluded from the cache-transfer paths and, without more, might become unutilized. As used herein, the term “cache-transfer path” refers to one or more serially connected memory nodes (e.g., L1-cache 130 and L2-cache 140) coupled between a processor (e.g., processor 110) and a main memory (e.g., system memory 150) with the purpose of storing copies of the most-frequently-used and/or anticipated-to-soon-be-used data from the main memory by sequentially transferring said copies from a more-remote memory node (e.g., L2-cache 140) to a less-remote memory node (e.g., L1-cache 130) toward the processor. To at least partially utilize the potentially unutilized storage capacity of the excluded L2-cache 140, SoC 100 configures the memory cells of the L2-cache to function as an extension 220 of local memory 120, as indicated by the arrow in FIG. 2.

Tables 1 and 2 illustrate a representative change in the memory map effected in SoC 100 to enable the excluded L2-cache 140 to function as extension 220. More specifically, Table 1 shows a representative memory map for a configuration, in which L2-cache 140 is excluded from the cache-transfer path and remains unutilized, and Table 2 shows a representative memory map corresponding to the configuration shown in FIG. 2. One skilled in the art will appreciate that, in various embodiments, the memory maps corresponding to Tables 1 and 2 might have more or fewer entries. Typically, a memory map analogous to one of those shown in Tables 1 and 2 has additional entries (omitted in the tables for the sake of brevity).

TABLE 1
Memory Map for a Configuration in Which the L2-Cache Is
Bypassed and Unutilized

| Device | Address Range (Hexadecimal) | Size (Kbytes) |
|---|---|---|
| Internal ROM | FFFF_FFFF-FFFF_0000 | 64 |
| System Memory | C07F_FFFF-C000_0000 | 16 × 512 |
| -reserved 1- | B007_FFFF-B000_0000 | 512 |
| -reserved 2- | 8C0B_FFFF-8C04_0000 | 512 |
| Local Memory | 8C03_FFFF-8C00_0000 | 256 |
| Flash Controller | 3001_FFFF-3001_0000 | 64 |

TABLE 2
Memory Map for a Configuration in Which the L2-Cache Is
Bypassed and Appended to a Local Memory

| Device | Address Range (Hexadecimal) | Size (Kbytes) |
|---|---|---|
| Internal ROM | FFFF_FFFF-FFFF_0000 | 64 |
| System Memory | C07F_FFFF-C000_0000 | 16 × 512 |
| -reserved 1- | B007_FFFF-B000_0000 | 512 |
| Local Memory Extension | 8C0B_FFFF-8C04_0000 | 512 |
| Local Memory | 8C03_FFFF-8C00_0000 | 256 |
| Flash Controller | 3001_FFFF-3001_0000 | 64 |

Referring to both Tables 1 and 2, the two memory maps have five identical entries for: (i) an internal ROM (not explicitly shown in FIG. 1 or 2); (ii) system memory 150 having sixteen memory blocks, each having a size of 512 Kbytes; (iii) a first reserved address range; (iv) local memory 120; and (v) a flash controller (not explicitly shown in FIG. 1 or 2). Reserved addresses are addresses that are not currently assigned to any of the devices or memory components in SoC 100. As such, these addresses are not operatively invoked in SoC 100. Note that cache-memory components do not normally show up in memory maps as independent entries because they contain copies of the data stored in system memory 150 and are indexed and tagged as such using the original data addresses corresponding to the system memory.

The third from the bottom entry in Table 1 specifies a second reserved address range that is immediately adjacent to the address range corresponding to local memory 120. In contrast, the third from the bottom entry in Table 2 specifies that those previously reserved addresses have been removed from the reserve and allocated to the memory cells of L2-cache 140. Because the excluded L2-cache 140 now has its own address range independent of that of system memory 150, the L2-cache no longer functions in its “cache” capacity, but rather can function as an independently addressable memory unit. In other words, when L2-cache 140 is a part of the cache-transfer path that couples system memory 150 and processor 110, the L2-cache memory does not function as an independently addressable memory unit. However, when excluded from that cache-transfer path and assigned its own address range, the memory cells of L2-cache 140 become independently addressable.

Logically, the memory cells of L2-cache 140 now represent an extension of local memory 120 because the two corresponding address ranges can be concatenated to form a continuous expanded address range running from hexadecimal address 8C00_{—}0000 to hexadecimal address 8C0B_FFFF (see Table 2). An extended local memory 240 (which includes local memory 120 and extension 220) is functionally analogous to local memory 120 and can be used by processor 110 for storing data that do not necessarily need committing to system memory 150. As a result, extended local memory 240 may contain data of which system memory 150 does not have a copy. Alternatively or in addition, SoC 100 can use DMA controller 160 to move instructions and application data between extended local memory 240 and system memory 150, e.g., to mirror a portion of the contents from the system memory.

In operation, processor 110 can access memory cells of extended local memory 240 having addresses from the hexadecimal address range of local memory 120 (i.e., 8C03_FFFF-8C00_{—}0000) directly via bus 112. Memory operations corresponding to this portion of extended local memory 240 are characterized by an access time of zero clock cycles. Processor 110 can access memory cells of extended local memory 240 having addresses from the hexadecimal address range allocated to the memory cells of L2-cache 140 (i.e., 8C0B_FFFF-8C04_{—}0000) via the on-chip bus (not explicitly shown) that connects to bus 112, with bus 112 being reconfigurable to be able to handle either the original 8C03_FFFF-8C00_{—}0000 address range or the extended 8C0B_FFFF-8C00_{—}0000 address range. Memory operations corresponding to extension 220 of extended local memory 240 are characterized by an access time of 2-3 clock cycles.

To summarize, in the configuration of FIG. 2, the size of the local memory has advantageously been tripled by utilizing the memory cells of the excluded L2-cache 140. The cost associated with this local-memory expansion is that, for access to an upper portion of the address range of extended local memory 240, i.e., the addresses corresponding to extension 220, processor 110 incurs a stall time of 2-3 clock cycles. Note however that the stall time is incurred only when the address sequence crosses (in the upward direction) the boundary between the address range corresponding to local memory 120 and the address range corresponding to extension 220, and not necessarily for each instance of access to the data stored in extension 220. In particular, if, after ascending across the range boundary, the address sequence remains in the address range of extension 220, then processor 110 does not incur any additional stall time due to its ability to pipeline memory access operations. In the pipeline processing, memory latency corresponding to each subsequent instance of access to extension 220 is offset by the time period corresponding to the initial processor stall because the pipeline is able to essentially propagate that time period down the pipeline to the subsequent instance(s) of access to extension 220.

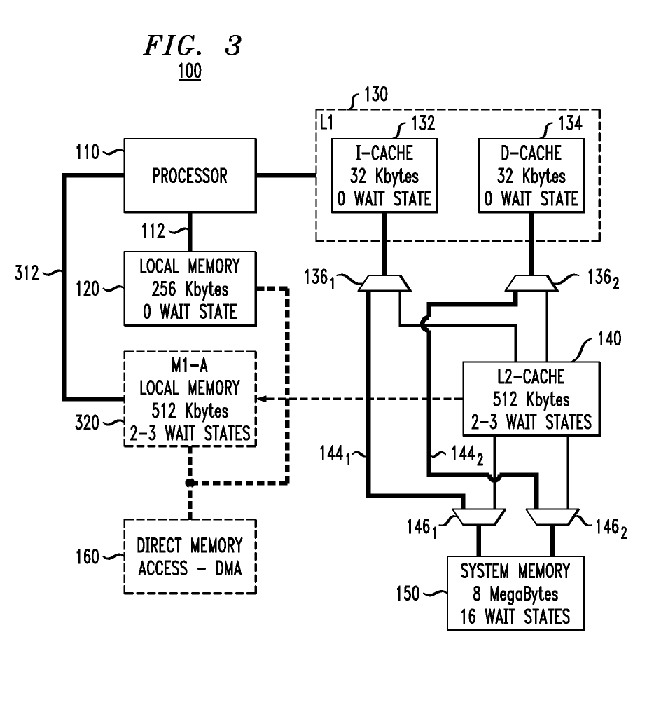

FIG. 3 shows a configuration of SoC 100 according to another embodiment of the invention. Similar to the configuration of FIG. 2, in the configuration of FIG. 3, MUXes 136 and 146 are configured to select lines 144₁ and 144₂, which leaves L2-cache 140 outside the cache-transfer paths. To at least partially utilize the storage capacity of the excluded L2-cache 140, SoC 100 configures the memory cells of L2-cache to function as an additional, separate local memory 320, as indicated by the arrow in FIG. 3. Table 3 shows a representative memory map corresponding to the configuration shown in FIG. 3. This configuration is described below in reference to Tables 1 and 3.

TABLE 3
Memory Map for a Configuration in Which the L2-Cache Is
Bypassed and Reconfigured as a Second Local Memory

| Device | Address Range (Hexadecimal) | Size (Kbytes) |
|---|---|---|
| Internal ROM | FFFF_FFFF-FFFF_0000 | 64 |
| System Memory | C07F_FFFF-C000_0000 | 16 × 512 |
| Second Local Memory | B007_FFFF-B000_0000 | 512 |
| -reserved 2- | 8C0B_FFFF-8C04_0000 | 512 |
| First Local Memory | 8C03_FFFF-8C00_0000 | 256 |
| Flash Controller | 3001_FFFF-3001_0000 | 64 |

The memory maps shown in Tables 1 and 3 have five identical entries for: (i) the internal ROM, (ii) system memory 150, (iii) the second reserved memory range, (iv) local memory 120, and (v) the NAND flash controller. The fourth from the bottom entry in Table 1 lists the first reserved address range, which is not immediately adjacent to the address range corresponding to local memory 120. In contrast, the fourth from the bottom entry in Table 3 specifies that those previously reserved addresses have been removed from the reserve and are now allocated to the excluded L2-cache 140, which becomes local memory 320.

Since there is a gap between the address range of local memory 320 and the address range of local memory 120, local memory 320 functions as a second local memory that is separate from and independent of local memory 120. Similar to local memory 120, local memory 320 can be used by processor 110 for storing data that do not necessarily need committing to system memory 150. As a result, local memory 320 may contain data of which system memory 150 does not have a copy. Alternatively or in addition, SoC 100 can use DMA controller 160 to move instructions and application data between local memory 320 and system memory 150, e.g., to mirror a portion of the contents from the system memory. In operation, processor 110 can access memory cells of local memory 320 via an on-chip bus 312 using an address belonging to the corresponding hexadecimal address range specified in Table 3 (i.e., B007_FFFF-B000_{—}0000). Memory operations corresponding to local memory 320 are characterized by an access time of 2-3 clock cycles inherited from L2-cache 140.

To summarize, in the configuration of FIG. 3, processor 110 has two tiers of local memory. The first tier of local memory (having local memory 120) is relatively fast (has an access time of zero clock cycles), but has a relatively small size. The second tier (having local memory 320) has a relatively large size, but is relatively slow (has an access time of 2-3 clock cycles). Due to these characteristics, local memory 320 is most beneficial as an overflow local-memory unit, which is invoked when local memory 120 is filled to capacity.

FIG. 4 shows a block diagram of an SoC 400 in which additional embodiments of the invention can be practiced. SoC 400 is a multi-processor SoC having four sub-systems 402A-D, each generally analogous to SoC 100 (see FIG. 1). Each sub-system 402 has a respective processor 410 that is coupled to a respective local memory 420 and a respective L1-cache 430. Each sub-system 402 also has a respective L2-cache 440. SoC 400 has a system memory 450 that is shared by all four sub-systems 402A-D. System memory 450 can be accessed by each of sub-systems 402A-D via an on-chip bus 448 and/or using a corresponding DMA controller 460. A transfer of instructions and application data between system memory 450 and an L1-cache 430 can occur either directly or via the corresponding L2-cache 440. For a direct transfer, the corresponding 1×2 multiplexers (MUXes) 436 and 446 are configured to exclude the L2-cache 440 from the cache-transfer path. For a transfer via the L2-cache 440, MUXes 436 and 446 are configured to select the lines that insert the L2-cache into the cache-transfer path as an intermediate node.

FIG. 5 shows a configuration of SoC 400 according to one embodiment of the invention. More specifically, in the configuration of FIG. 5, MUXes 436 and 446 in each of sub-systems 402A-D are configured to exclude the corresponding L2-cache 440 from the corresponding cache-transfer path, which enables a direct transfer of instructions and application data between each of L1-caches 430 and system memory 450. To at least partially utilize the unutilized storage capacity of the excluded L2-caches 440A-D, one or more of the excluded L2-caches can be configured to function as an extension 550 of system memory 450, e.g., as indicated in FIG. 5.

Tables 4 and 5 illustrate a representative change in the memory map effected in SoC 400 to enable the excluded L2-caches 440A-D to function as system-memory extension 550. More specifically, Table 4 shows a representative memory map for a configuration, in which L2-caches 440A-D are excluded from the corresponding cache-transfer paths but remain unutilized. Table 5 shows a representative memory map corresponding to the configuration shown in FIG. 5. One skilled in the art will appreciate that the memory maps of Tables 4 and 5 might have additional entries that are omitted in the tables for the sake of brevity.

TABLE 4
Memory Map for a Configuration in Which the L2-Caches Are
Bypassed and Unutilized

| Device | Address Range (Hexadecimal) | Size (Kbytes) |
|---|---|---|
| System Memory | C07F_FFFF-C000_0000 | 16 × 512 |
| -reserved 1- | BFFF_FFFF-BFF8_0000 | 512 |
| -reserved 2- | BFF7_FFFF-BFF0_0000 | 512 |
| -reserved 3- | BFEF_FFFF-BFE8_0000 | 512 |
| -reserved 4- | BFE7_FFFF-BFE0_0000 | 512 |
| Local Memory D | 8C03_FFFF-8C00_0000 | 256 |
| Local Memory C | 8803_FFFF-8800_0000 | 256 |
| Local Memory B | 8403_FFFF-8400_0000 | 256 |
| Local Memory A | 8003_FFFF-8000_0000 | 256 |

TABLE 5
Memory Map for a Configuration in Which the L2-Caches Are
Bypassed and Pre-pended to the System Memory

| | | Size |
|---|---|---|
| Device | Address Range (Hexadecimal) | (Kbytes) |
| System Memory | C07F_FFFF-C000_0000 | 16 × 512 |
| System-Memory Extension D | BFFF_FFFF-BFF8_0000 | 512 |
| System-Memory Extension C | BFF7_FFFF-BFF0_0000 | 512 |
| System-Memory Extension B | BFEF_FFFF-BFE8_0000 | 512 |
| System-Memory Extension A | BFE7_FFFF-BFE0_0000 | 512 |
| Local Memory D | 8C03_FFFF-8C00_0000 | 256 |
| Local Memory C | 8803_FFFF-8800_0000 | 256 |
| Local Memory B | 8403_FFFF-8400_0000 | 256 |
| Local Memory A | 8003_FFFF-8000_0000 | 256 |

The memory maps shown in Tables 4 and 5 have five identical entries for: (i) system memory 450, (ii) local memory 420D, (iii) local memory 420C, (iv) local memory 420B, and (v) local memory 420A. The four “reserved” entries in Table 4 list four address ranges that can be concatenated to form a combined continuous address range immediately adjacent to the lower boundary of the address range corresponding to system memory 450. In contrast, Table 5 indicates that those previously reserved addresses have been removed from the reserve and are now allocated, as shown, to the excluded L2-caches 440A-D. As a result, the excluded L2-caches 440A-D no longer function in their “cache” capacity, but rather form system-memory extension 550. Together, regular system memory 450 and system-memory extension 550 form an extended system memory 540 that has an advantageously larger capacity than the regular system memory alone. In addition, access to extension 550 inherits the latency of individual L2-caches 440A-D, which is lower than the latency of regular system memory 450 (e.g., 2-3 clock cycles versus 16 clock cycles, see FIGS. 4-5). As a result, extended system memory 540 has an advantageously lower effective latency than system memory 450 alone.

In an alternative configuration, not all of L2-caches 440A-D might be excluded from the corresponding cache-transfer paths. In that case, the memory map of Table 5 is modified so that only the excluded L2-caches 440 receive an allocation of the previously reserved addresses (see also Table 4). As various L2-caches 440 change their status from being included into the corresponding cache-transfer path to being excluded from it, it is preferred, but not necessary, that address range “reserved 1” is assigned first, address range “reserved 2” is assigned second, etc., to maintain a continuity of addresses for extended system memory 540. Similarly, as various L2-caches 440 change their status from being excluded from the corresponding cache-transfer path to being included into it, it is preferred, but not necessary, that address range “reserved 1” is de-allocated last, address range “reserved 2” is de-allocated next to last, etc.

While this invention has been described with reference to illustrative embodiments, this description is not intended to be construed in a limiting sense. Although embodiments of the invention have been described in reference to an embedded memory having a two-level cache memory, the invention can similarly be practiced in embedded memories having more than two levels of cache memory, where one or more intermediate cache levels are bypassed and remapped to function as an extension of the local memory, a separate additional local memory, or an extension of the system memory. Although embodiments of the inventions, in which an L2-cache is configured to function as an extension of a local memory or a separate additional local memory, have been described in reference to an SoC having a single processor, these L2-cache configurations can similarly be used in an SoC having multiple processors. Although embodiments of the inventions, in which an L2-cache is configured to function as an extension of a system memory, have been described in reference to an SoC having multiple processors, a similar L2-cache configuration can also be used in an SoC having a single processor. The addresses and address ranges shown in Tables 1-5 are merely exemplary and should not be construed as limiting the scope of the invention. In an SoC having more than two levels of cache memory, two or more levels of cache memory can similarly be excluded from a corresponding cache-transfer path and each of the excluded levels can be configured to function as an extension of the local memory, a separate additional local memory, and/or an extension of the system memory. The corresponding SoC configurations can be achieved via software or via hardware and can be reversible or permanent. Various memory circuits, such as SRAM (static RAM), DRAM, and or flash, can be used to implement various embedded memory components. Various modifications of the described embodiments, as well as other embodiments of the invention, which are apparent to persons skilled in the art to which the invention pertains are deemed to lie within the principle and scope of the invention as expressed in the following claims.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a single-processor SoC or a multi-processor SoC, the machine becomes an apparatus for practicing the invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. A method of operating an embedded memory, the method comprising:
excluding a first memory circuit of a first multi-level cache memory from a cache-transfer path that couples a first processor and a system memory, wherein the embedded memory comprises:
the system memory; and
the first multi-level cache memory coupled between the first processor and the system memory and having (i) a first level-one (L1) cache directly coupled to the first processor and (ii) the first memory circuit coupled between the first L1-cache and the system memory; and
mapping the first memory circuit as an independently addressable memory unit within the embedded memory.

2. The invention of claim 1, wherein the first memory circuit is configurable to function as a level-two (L2) cache in the cache-transfer path.

3. The invention of claim 1, further comprising reserving an address range in a memory map of the embedded memory, wherein:
the step of reserving is performed before the step of excluding; and
the step of mapping comprises assigning the reserved address range to the first memory circuit.

4. The invention of claim 3, wherein the assigned address range does not overlap with any address range corresponding to the system memory.

5. The invention of claim 3, wherein:
the assigned address range and an address range corresponding to the system memory form a continuous extended address range; and
the first memory circuit functions as an extension of the system memory.

6. The invention of claim 5, further comprising preventing writing data to the system memory if the first memory circuit has available storage space, wherein the system memory is characterized by a higher latency than the first memory circuit.

7. The invention of claim 3, wherein:
the embedded memory further comprises a local memory directly coupled to the first processor;
the assigned address range and an address range corresponding to the local memory form a continuous extended address range; and
the first memory circuit functions as an extension of the local memory.

8. The invention of claim 7, wherein said extension of the local memory contains at least one application datum or instruction of which the system memory never contains a copy.

9. The invention of claim 7, further comprising transferring data from or to said extension of the local memory using a direct-memory-access (DMA) controller.

10. The invention of claim 1, wherein the first memory circuit functions as a local memory for the first processor and contains at least one application datum or instruction of which the system memory never contains a copy.

11. The invention of claim 1, wherein the embedded memory further comprises a second multi-level cache memory coupled between a second processor and the system memory and having (i) a second L1-cache directly coupled to the second processor and (ii) a second memory circuit coupled between the second L1-cache and the system memory.

12. The invention of claim 11, further comprising reserving a first address range in a memory map, wherein:
the step of reserving is performed before the step of excluding;
the step of mapping comprises assigning the first reserved address range to the first memory circuit;
the first assigned address range and an address range corresponding to the system memory form a continuous extended address range;
the first memory circuit functions as an extension of the system memory; and
the second memory circuit functions as a level-two (L2) cache in the second multi-level cache memory.

13. The invention of claim 11, further comprising:
excluding the second memory circuit from a cache-transfer path that couples the second processor and the system memory; and
mapping the second memory circuit as an independently addressable memory unit within the embedded memory.

14. The invention of claim 13, wherein:
the first memory circuit is configurable to function as a first level-two (L2) cache in the cache-transfer path that couples the first processor and the system memory; and
the second memory circuit is configurable to function as a second L2-cache in the cache-transfer path that couples the second processor and the system memory.

15. The invention of claim 13, further comprising reserving first and second address ranges in a memory map, wherein:
the step of reserving is performed before the steps of excluding;
the step of mapping comprises (i) assigning the first reserved address range to the first memory circuit and (i) assigning the second reserved address range to the second memory circuit;
the first and second assigned address ranges and an address range corresponding to the system memory form a continuous extended address range; and
the first and second memory circuits function as an extension of the system memory.

16. The embedded memory produced by the method of claim 1.

17. A method of operating an embedded memory, the method comprising:
engaging a first memory circuit of a first multi-level cache memory into a cache-transfer path that couples a first processor and a system memory, wherein:
the embedded memory comprises:
the system memory; and
the first multi-level cache memory coupled between the first processor and the system memory and having (i) a first level-one (L1) cache directly coupled to the first processor and (ii) the first memory circuit coupled between the first L1-cache and the system memory; and
the first memory circuit is configurable to function as an independently addressable memory unit within the embedded memory if assigned a corresponding address range in a memory map of the embedded memory; and
reserving in the memory map an address range for possible assignment to the first memory circuit.

18. The invention of claim 17, wherein, prior to said engagement, the first memory circuit functioned as an extension of a local memory for the first processor, a independent local memory for the first processor, or an extension of the system memory.

19. The invention of claim 17, wherein, after said engagement, the first memory circuit functions as a level-two cache in the cache-transfer path.

20. An embedded memory, comprising:
a system memory;
a multi-level cache memory coupled between a first processor and the system memory, wherein the multi-level cache memory comprises (i) a first level-one (L1) cache directly coupled to the first processor and (ii) a first memory circuit coupled between the first L1-cache and the system memory; and
a routing circuit that:
in a first routing state, engages the first memory circuit into a cache-transfer path that couples the first processor and the system memory; and
in a second routing state, excludes the first memory circuit from the cache-transfer path, wherein the first memory circuit is configurable to function as (i) a level-two cache if engaged in the cache-transfer path and (ii) an independently addressable memory unit within the embedded memory if excluded from the cache-transfer path.
